(19) United States
(12) Patent Application Publication
(10) Pub. No.: US 2009/0303327 A1
(43) Pub. Date: Dec. 10, 2009

(54) Security System

(76) Inventor: Tadasu HORIUCHI, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/478,205

(22) Filed: Jun. 4, 2009

(30) Foreign Application Priority Data
Jun. 5, 2008 (JP) 2008-148116

(51) Int. Cl. H04N 7/18

(52) U.S. Cl. 348/152; 348/E07.085

(57) ABSTRACT

This invention provides a security system that includes: a surveillance camera unit including a video camera and a paint bullet firing apparatus for firing a paint bullet from a firing port arranged along the direction of the axis of the line of sight of the video camera; a user interface for displaying an image from the video camera and accepting a predetermined input from an operator; and a controller for remote-controlling the surveillance camera unit. The controller extracts a predetermined photographic subject from an image sent from the video camera; sets the predetermined photographic subject as a target according to an instruction from the user interface; and controls the direction of the surveillance camera unit to position the predetermined photographic subject in the vicinity of the center of the image. The controller then issues a command to fire the paint bullet according to a second input from the user interface.

### CROSS-REFERENCES TO RELATED APPLICATIONS

This application relates to and claims priority from Japanese Patent Application No. 2008-148116, filed on Jun. 5, 2008, the entire disclosure of which is incorporated herein by reference.

### BACKGROUND

1. Field of the Invention

The present invention relates to a security system using a surveillance camera for crime prevention/security. It particularly relates to a security system using a remote controllable surveillance camera including a mechanism for helping apprehend suspicious figures.

2. Description of Related Art

Lately, with the increase in the number of serious crimes such as robberies in financial institutions and stores, it has become an urgent necessity to expand crime-prevention measures. For example, by increasing the number of surveillance cameras installed and remotely operating them, blind spots in the monitoring range have been reduced. Moreover, a system has been suggested in which, in an emergency such as during the occurrence of a crime, a remote operator can shoot a so-called paint bullet at a suspicious figure while observing the image taken by the surveillance camera.

JP2002-298261 AP (incorporated herein by reference) discloses a network-type emergency reporting system using security light poles. Specifically speaking, it discloses a technique whereby, when an emergency call switch of a security light pole is operated, an observer on the crime prevention/surveillance control server side remotely controls a relevant marking material ejector and ejects the marking material toward a suspicious figure while observing the site through a surveillance camera arranged in the security light pole.

With the above-described conventional network-type emergency reporting system using security light poles, the observer observes the captured video (images) taken by the surveillance cameras and activates a relevant marking material ejector when the suspicious figure approaches a particular security light pole. Accordingly, in the conventional system, the target of the marking material ejector is not associated with the image from the surveillance camera and, because the sighting direction of the marking material ejector cannot be controlled, the conventional system requires skills for remote control and enhanced ease of operation.

It is an object of this invention to provide a security system using a surveillance camera including a mechanism that can be easily operated and capable of firing, for example, a paint bullet at a target with high accuracy.

### SUMMARY

This invention has been devised to achieve the above object and is a security system using a surveillance camera unit including a paint bullet firing apparatus that is integrally formed with a video camera.

According to an aspect of this invention, provided is a security system including: a surveillance camera unit including: a video camera; and a paint bullet firing apparatus for firing a paint bullet from a firing port that is arranged aligned in a direction of an axis of line of sight of the video camera; a user interface for displaying an image that is sent from the video camera and accepting a predetermined input with respect to the displayed image from an operator; and a controller for controlling the surveillance camera unit. The controller includes: an image recognizer for extracting a predetermined photographic subject from an image that is sent from the video camera; a target selector for setting, according to a first input it receives from the user interface, the predetermined photographic subject as a target and controlling the direction of the surveillance camera unit so that the predetermined photographic subject is positioned in the vicinity of the center of the image; and a firing command issuer for issuing a paint bullet firing command to the paint bullet firing apparatus according to a second input it receives from the user interface.

This invention makes it possible for an operator to easily train the sight of a paint bullet firing apparatus on a target while observing the image from the surveillance camera, therefore ensuring that the paint bullet hits the target.

Other aspects and advantages of the invention will be apparent from the following description and the appended claims.

### BRIEF DESCRIPTION OF THE DRAWINGS

FIG. 1 is an appearance diagram of a surveillance camera unit that is used in a security system according to Embodiment 1 of the invention.

FIG. 2 is a block diagram illustrating the structure of the security system according to Embodiment 1 of the invention.

FIG. 3 is a flowchart for explaining processing by a controller in a terminal device according to an embodiment of the invention.

FIG. 4 is a schematic diagram of a floor where the surveillance camera unit according to Embodiment 1 of the invention is placed.

FIG. 5 is a diagram showing an example of an image shown on a touch panel screen, the image being taken by the surveillance camera unit according to Embodiment 1 of the invention.

FIG. 6 is a schematic diagram of a floor where the surveillance camera unit according to Embodiment 1 of the invention is placed.

FIG. 7 is a diagram showing an example of image shown on the touch panel screen, the image being taken by the surveillance camera unit according to Embodiment 1 of the invention.

FIG. 8 is a flowchart for explaining operation of a controller in a terminal device according to Embodiment 2 of the invention.

FIG. 9 is a flowchart for explaining operation of a controller in a terminal device according to Embodiment 3 of the invention.

FIG. 10 is a block diagram illustrating a security system according to Embodiment 4 of the invention.

FIG. 11 is a schematic diagram of a floor where a surveillance camera unit according to Embodiment 4 of the invention is placed.

FIG. 12 is a diagram showing an example of an image shown on a touch panel screen in the surveillance camera unit according to Embodiment 4 of the invention.

FIG. 13 is a block diagram illustrating the structure of a security system according to Embodiment 5 of the invention.

FIG. 14 is a flowchart for explaining processing by a controller in a terminal device according to Embodiment 5 of the invention.

FIG. 15 is a diagram illustrating a firing angle of a paint bullet that is fired from a paint bullet firing apparatus according to Embodiment 5 of the invention.

FIG. 16 is a block diagram illustrating the structure of a security system according to Embodiment 6 of the invention.

FIG. 17 is an appearance diagram of a surveillance camera unit that is used in a security system according to Embodiment 7 of the invention.

### DETAILED DESCRIPTION OF PREFERRED EMBODIMENTS

Embodiments of the invention will be described below in detail with reference to the attached drawings.

### Embodiment 1

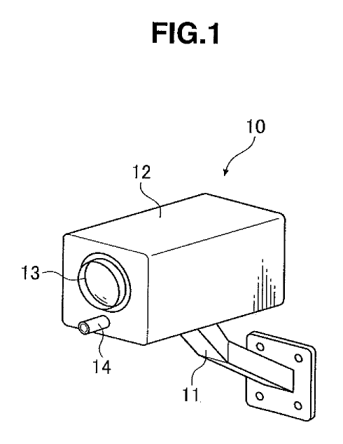

FIG. 1 is an appearance diagram of a surveillance camera unit that is used in a security system according to Embodiment 1 of the invention. It shows a surveillance camera unit 10 mounted on, for example, a wall via an arm 11. The surveillance camera unit 10 is placed, for example, in a financial institution or a convenience store. The surveillance camera unit 10 contains in its casing 12, for example, a video camera body, a paint bullet firing apparatus, and a control mechanism (not shown in the drawing). FIG. 1 shows a lens 13 of the video camera body and a firing port 14 of the paint bullet firing apparatus, which are exposed from the front face of the casing 12. Incidentally, it is possible to employ a structure where the paint bullet firing mechanism is integrally mounted outside the casing 12, instead of being contained in the casing 12.

The surveillance camera unit 10 in Embodiment 1 is remote controllable so that an operator at a remote site can operate a control panel to control, for example, the direction of the axis of line of sight (so-called camera angle) of the surveillance camera unit 10 and the firing of paint bullets.

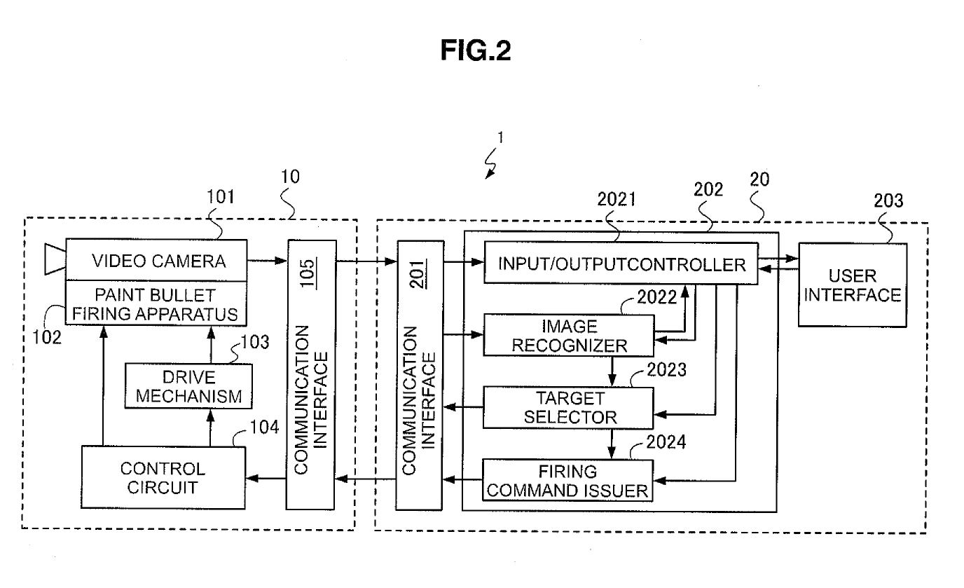

FIG. 2 is a block diagram illustrating the structure of a security system according to Embodiment 1 of this invention. As shown in the drawing, the security system 1 in Embodiment 1 is structured including the surveillance camera unit 10 and a terminal device 20 that is placed at a remote site, for example, in a security center.

The surveillance camera unit 10 includes a video camera 101, a paint bullet firing apparatus 102, a drive mechanism 103, a control circuit 104, and a communication interface 105.

The video camera 101 sends a video signal obtained by imaging through a lens 13 (FIG. 1) to the terminal device 20. The paint bullet firing apparatus 102 is an apparatus for firing paint bullets by using, for example, air pressure in response to a firing instruction from the terminal device 20. A paint bullet is, typically, a capsule or a container filled with, for example, a coloring material, the capsule or container bursting easily upon collision.

The drive mechanism 103 is composed of, for example, a drive motor and a drive gear, and drives, under the control of the control circuit 104, the surveillance camera unit 10 to control the direction of the axis of the line of sight. The drive control includes, in addition to the direction control, control of the focus and zoom of the video camera 101.

The control circuit 104 is a system circuit for integrally controlling the surveillance camera unit 10 and is composed of, for example, a CPU and memory. As described later, the control circuit 104 controls the drive mechanism 103 based on a control command from the terminal device 20 to direct the axis of the line of sight of the video camera 101 in a predetermined direction, and gives an instruction for firing a paint bullet to the paint bullet firing apparatus 102. The communication interface 105 is an interface board for communication with the terminal device 20.

The terminal device 20 includes a communication interface 201, a controller 202, and a user interface 203. The communication interface 201 is an interface board for communication with the surveillance camera unit 10 and interacts with the communication interface 106 in the surveillance camera unit 10.

The controller 202 typically includes, for example, a CPU, memory, an exclusive logic board, and an auxiliary memory (not shown in the drawing) and is structured to perform predetermined functions under the control of the CPU. The controller 202 in Embodiment 1 includes an input/output controller 2021, an image recognizer 2022, target selector 2023, and a firing command issuer 2024.

The input/output controller 2021 executes processing required for displaying video signals from the video camera 101 on the user interface 203 and accepts input signals from the user interface 203.

The image recognizer 2022 detects boundaries (contours) in an image that is based on a video signal from the video camera 101 and extracts a specific photographic subject to be recognized as a figure. Any number of specific photographic subjects may be extracted. For example, if people other than a criminal are also shown in the image, all the figures may be extracted as photographic subjects. A known image recognition technique can be used in Embodiment 1.

The target selector 2023 determines, based on input information (coordinate information) from the user interface 203, which will be described later, whether or not the specific photographic subject that had been extracted by the image recognizer 2022 has been specified. When it determines that the specific photographic subject has been specified, it performs a coordinate calculation for making the specific photographic subject positioned in the center of the image, and sends a control command that is based on this coordinate calculation to the control circuit 104 in the surveillance camera unit 10. This is because the sight of the paint bullet firing apparatus is trained on the center of the image. Accordingly, if the sight of the paint bullet firing apparatus is trained, for example, on a position somewhat below the center of the image, the target selector 2023 executes control such that the specified, specific photographic subject comes to that position. Meanwhile, if the target selector 2023 determines that the specified, specific photographic subject is moving, it tracks the specific photographic subject so that the subject is positioned in the center of the image.

When the firing command issuer 2024 detects a firing button—which will be described later—as having been selected, it sends a firing command to the control circuit 104 in the surveillance camera unit 10. However, in a “locked” state, even when the firing button is selected, the firing command issuer 2024 restrains itself from sending a firing command.

The user interface 203 provides an interactive operational environment to the operator. The user interface 203 in Embodiment 1 is structured with a touch panel screen. The user interface 203 displays, based on a video signal from the video camera 101, a captured image on the touch panel screen and sends an input signal that is generated by the operator's touch on the touch panel screen to the input/output controller 2021. In Embodiment 1, the operator can specify a photographic subject displayed on the touch panel screen so that the specified photographic subject is set as a target.

The user interface 203 displays a firing button and a firing mode switching button on the touch panel screen. The firing button is for firing a paint bullet from the paint bullet firing apparatus 102. When the firing command issuer 2024 detects the firing button as having been selected, it sends a firing command to the control circuit 104 in the surveillance camera unit 10. The firing mode switching button is one for switching between a locked state and a lock-released state (hereinafter simply called “unlocked state”). When the firing command issuer 2024 determines according to an input signal from the user interface 203 that the firing mode switching button has been selected, it selectively switches between the locked state and the unlocked state. The locked state is a state where even if the firing button is selected, firing of a paint bullet is prevented, while the unlocked state is a state where a paint bullet is fired upon selection of the firing button. This firing mode switching button prevents operational errors on the part of the operator. For example, the lock mode is set immediately after the terminal device 20 is powered on.

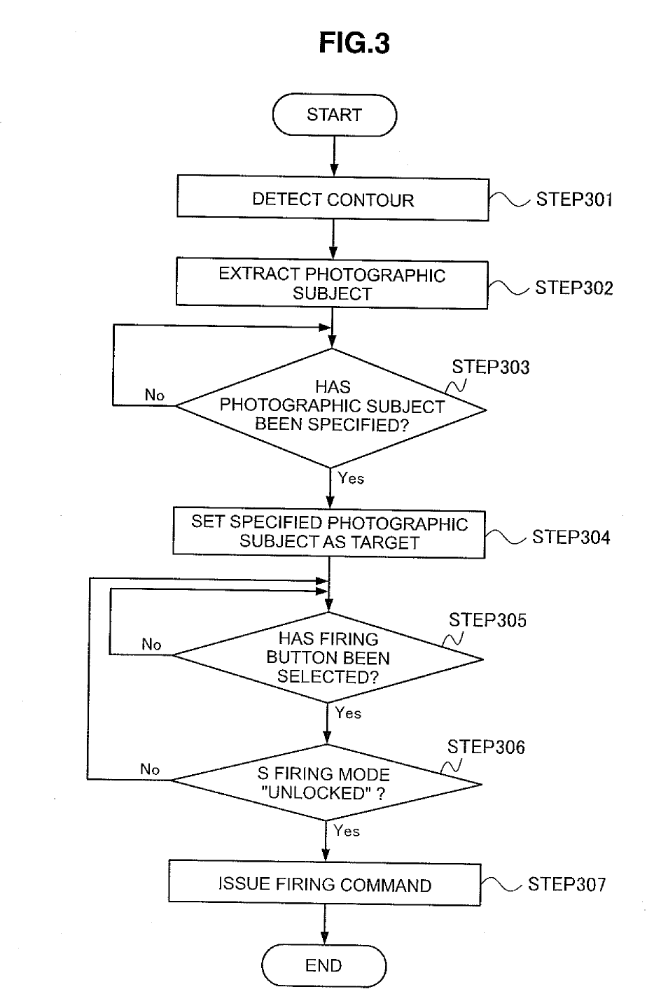

FIG. 3 is a flowchart for explaining processing by the controller 202 in the terminal device 20 according to an embodiment of this invention.

Specifically, as shown in FIG. 3, when the image recognizer 2022 in the controller 202 receives a video signal from the video camera 101, it detects a contour in the image using a predetermined image recognition technique (STEP301) and extracts a photographic subject that should be recognized as a figure (STEP302). The extracted photographic subject may be marked, for example, on the touch panel screen.

When the photographic subject has been extracted, the target selector 2023 determines, based on an input signal from the touch panel screen, whether or not the extracted photographic subject has been specified (STEP303). If the target selector 2023 determines that the photographic subject has been specified (STEP303: Yes), it sets the specified photographic subject as a target (STEP304). Specifically speaking, the target selector 2023 performs a coordinate calculation for making the specified photographic subject positioned in the center of the image and sends a control command that is based on this coordinate calculation to the control circuit 104 in the surveillance camera unit 10. As a result, the control circuit 104 controls the drive mechanism 103 to make the photographic subject be positioned in the center of the image. Consequently, the direction of the casing 12 of the surveillance camera unit 10 is controlled.

When the photographic subject has been specified, the firing command issuer 2024 monitors the firing button to determine whether or not the firing button has been selected (STEP305). When it detects the firing button having been selected (STEP305: Yes), it further determines whether or not the firing mode is the unlocked state (STEP306). If it determines that the firing mode is the locked state (STEP306; No), it regards the selection of the firing button as invalid and again monitors the firing button to determine whether the firing button has been selected (STEP305). Meanwhile, if the firing command issuer 2024 determines that the firing mode is the unlocked state (STEP306: Yes), it sends a firing command to the surveillance camera unit 10 (STEP307). Having received the firing command, the control circuit 104 in the surveillance camera unit 10 gives a paint bullet firing instruction to the paint bullet firing apparatus 102.

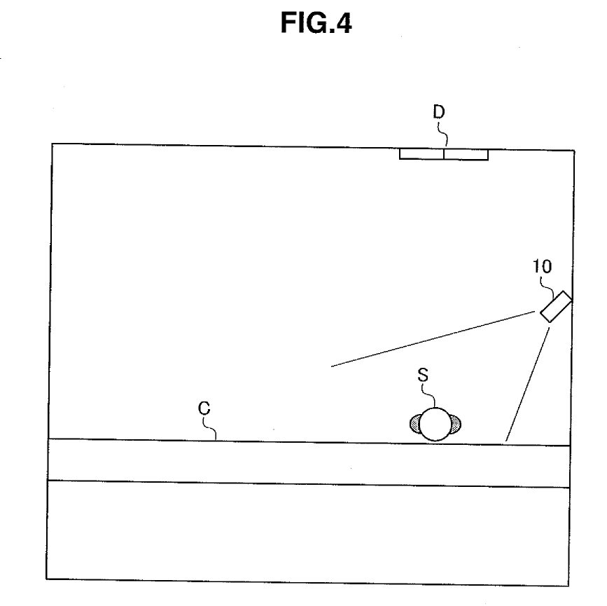

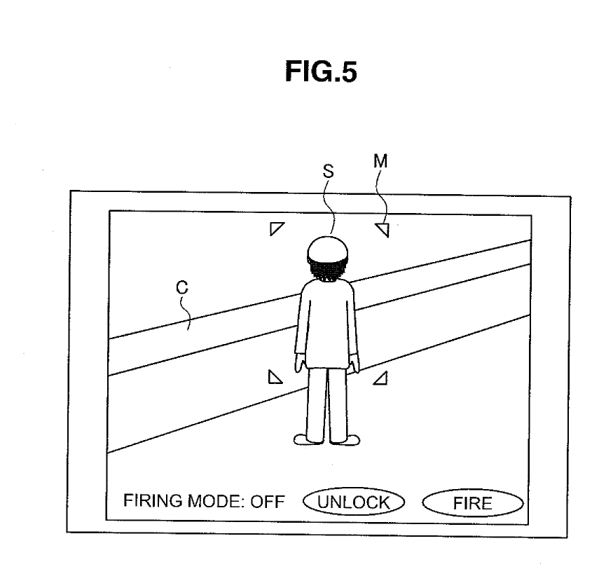

FIGS. 4-7 are schematic diagrams explaining operation of the security system according to Embodiment 1 of this invention. FIG. 4 is a plan view of, for example, a window floor of a financial institute, showing a situation where the axis of the line of sight of the surveillance camera unit 10 is directed at a suspicious figure S who is approaching window counter C. FIG. 5 shows an image taken by the surveillance camera unit 10 and displayed on the touch panel screen. In Embodiment 1, the mark “M” is superimposed on the photographic subject that is recognized by the image recognizer 2022. The operator in front of the terminal device 20 specifies the photographic subject by touching the photographic subject displayed on the touch panel screen with his/her finger. If the “unlock” button is displayed as the firing mode switching button, the operator selects it to switch the firing mode to the unlocked state. As a result, the firing-locked state is released and the paint bullet firing apparatus 102 is allowed to fire a paint bullet.

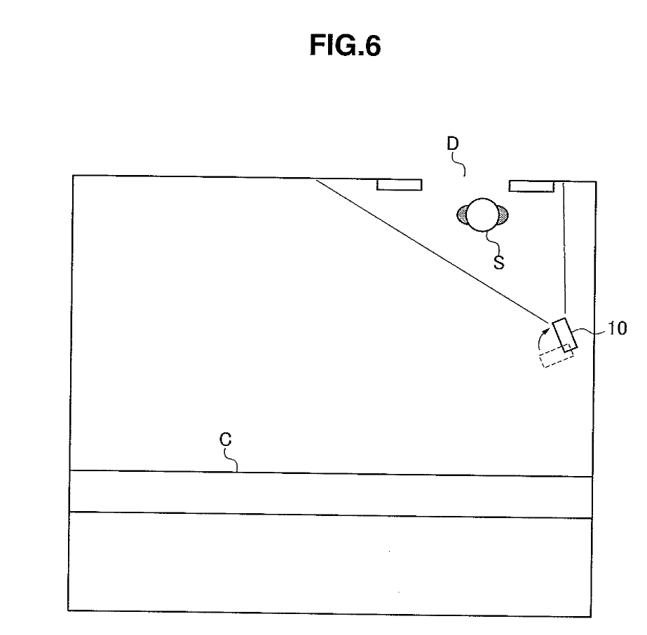

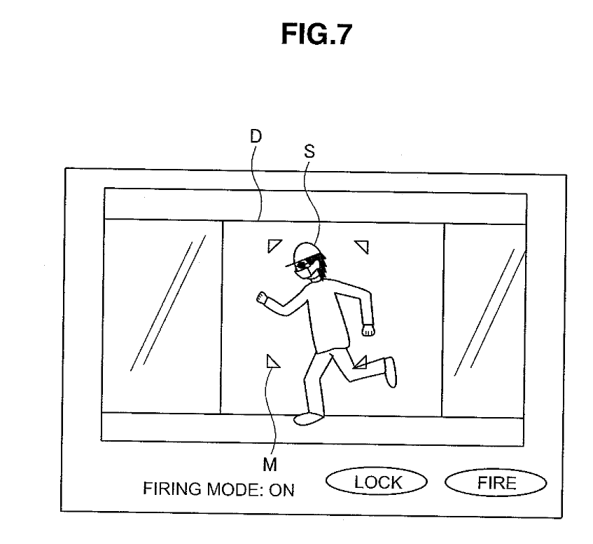

FIG. 6 shows that the axis of the line of sight of the surveillance camera unit 10 is directed at the suspicious figure S who is running away to a doorway D. FIG. 7 shows an image taken at this time by the surveillance camera unit 10 and displayed on the touch panel screen of the user interface 203. When the operator checks that the firing mode is the unlocked state and selects the firing button, the firing command issuer 2024 detects this and sends a firing command to the surveillance camera unit 10. As a result, the control circuit 104 in the surveillance camera unit 10 gives a firing instruction to the paint bullet firing apparatus 102 and consequently the paint bullet firing apparatus 102 fires a paint bullet.

Text such as “firing mode: ON” (unlocked state) or “firing mode: OFF” (locked state) may be displayed on the touch panel screen so that the current firing mode can be ascertained. Alternatively, it is possible to employ a configuration where the shape or color of the mark “M” visibly changes depending on the firing mode or, when the firing mode is the locked state, the firing button is displayed as being in a disenabled state.

As described above, according to Embodiment 1, the operator can easily train, by specifying a photographic subject in the image taken by the video camera 101 and displayed on the touch panel screen, the sight of the paint bullet firing apparatus 102 on the specified photographic subject. Therefore, after specifying the photographic subject, the operator selects the firing button on the touch panel screen to fire a paint bullet at the photographic subject. Moreover, when the firing mode is the locked state, the operator cannot fire a paint bullet unless he/she selects the firing mode switching button on the touch panel screen to switch the firing mode to the unlocked state. Accordingly, firing by mistake can be prevented.

### Embodiment 2

Embodiment 2 is characterized in that a moving photographic subject (moving body) in the image is set as a target and a paint bullet is fired at that subject.

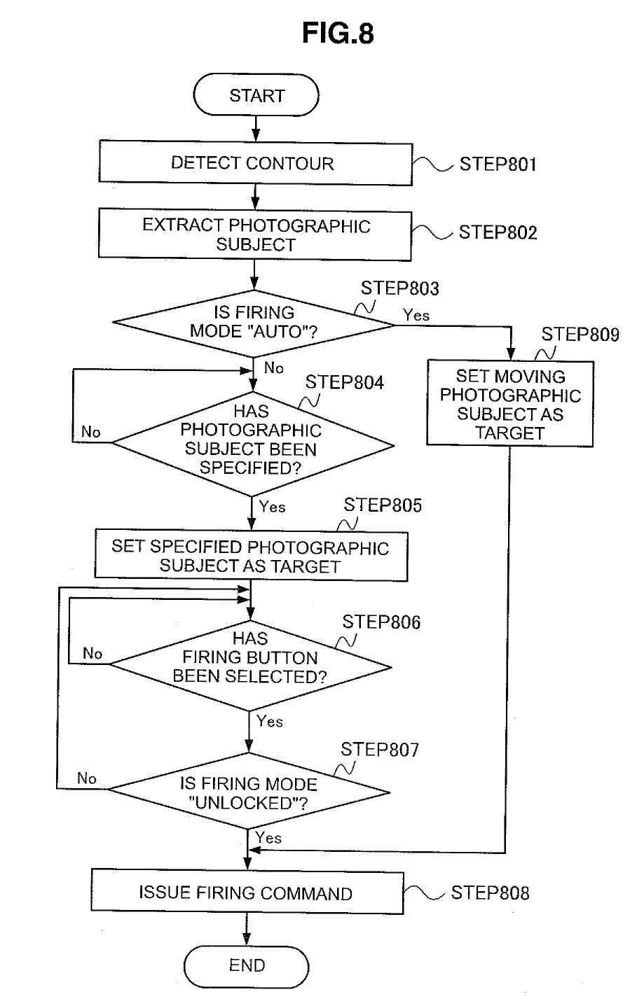

FIG. 8 is a flowchart for explaining operation by the controller 202 in the terminal device 20 according to Embodiment 2 of this invention. In this embodiment, respective states of “auto,” “manual (unlocked),” and “locked” are prepared as firing modes.

As shown in FIG. 8, the image recognizer 2022 detects a contour in an image that is based on a video signal (STEP801) and extracts a photographic subject (STEP802). In Embodiment 2, the image recognizer 2022 is configured to be capable of recognizing both still photographic subjects and moving photographic subjects.

The target selector 2023 then determines whether or not the firing mode is the auto state (STEP803). If it determines that the firing mode is not the auto state (STEP803; No), it executes the procedures STEP804 to STEP808. The procedures STEP804 to STEP808 are the same as the procedures STEP303 to STEP 307 explained in Embodiment 1, and thereby omitted.

Meanwhile, if the target selector 2023 determines that the firing mode is the auto state (STEP803: Yes), it sets the photographic subject that has been recognized as a moving object as a target (STEP809). The target selector 2023 executes control to track the photographic subject that has been set as a target so that it is positioned in the center of the image.

Then, the firing command issuer 2024 sends a firing command to the control circuit 104 in the surveillance camera unit 10 (STEP808). Having received the firing command, the control circuit 104 in the surveillance camera unit 10 gives a firing instruction to the paint bullet firing apparatus 102 and consequently the paint bullet firing apparatus 102 fires a paint bullet.

As described above, in the auto firing mode in Embodiment 2, it is possible to automatically set a moving photographic subject in the image as a target and fire a paint bullet at the target. Accordingly, if the firing mode is set to the auto state for an area where there should usually be no moving people, for example, a restricted area, it is possible to fire a paint bullet at a suspicious figure without requiring the operator's monitoring and specification. Moreover, because the firing mode can be switched also in Embodiment 2, flexible use of the security system 1 is made possible by the operator's selecting a firing mode according to a relevant purpose.

### Embodiment 3

Embodiment 3 is characterized in that a paint bullet is fired when a target that has been set is within a predetermined range in an image. The respective firing modes of “auto,” “manual (unlocked),” and “locked” are prepared as firing modes also in Embodiment 3.

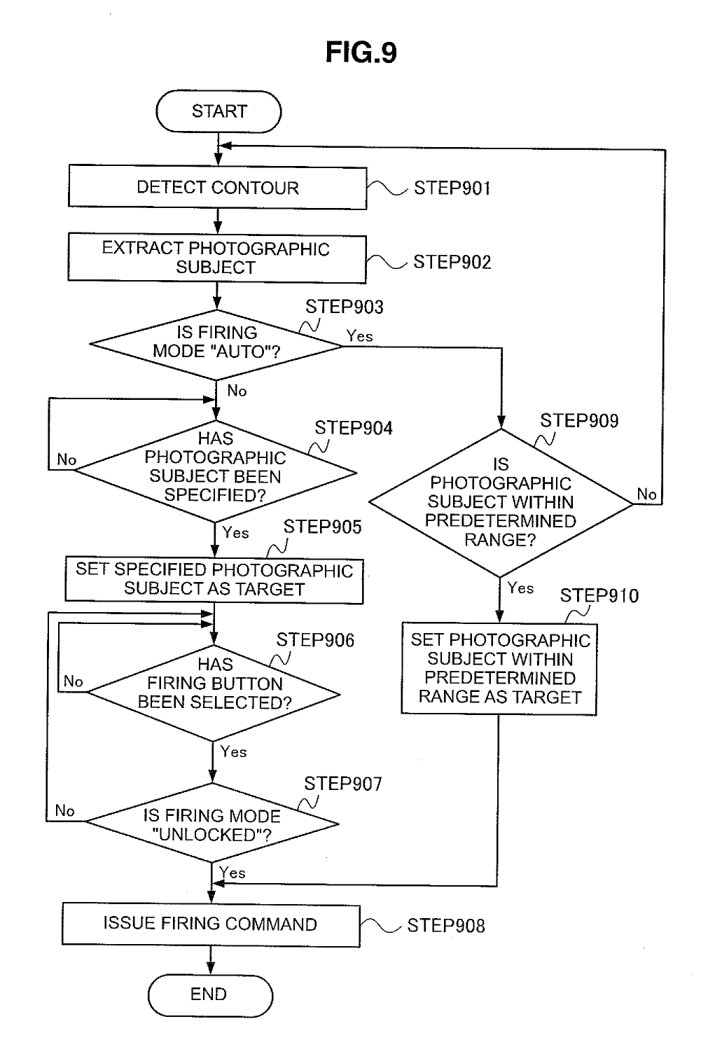

FIG. 9 is a flowchart for explaining operation by the controller 202 in the terminal device 20 according to Embodiment 3 of this invention.

As shown in FIG. 9, the image recognizer 2022 detects a contour in the image that is based on a video signal (STEP901) and extracts a photographic subject (STEP902).

Next, the target selector 2023 determines whether or not the firing mode is the “auto” state (STEP903). If it determines that the firing mode is not the “auto” state (STEP903; No), it performs the procedures STEP904 to STEP908. The procedures STEP904 to STEP908 are the same as the procedures STEP303 to STEP307 in FIG. 3 that have been explained with regard to Embodiment 1, and so accordingly have been omitted.

Meanwhile, if the target selector 2023 determines that the firing mode is the “auto” state (STEP903: Yes), it further determines whether or not the extracted photographic subject is positioned within a predetermined range (STEP909). Specifically speaking, when the surveillance camera unit 10 is directed in a predetermined direction of the axis of the line of sight, the target selector 2023 determines whether or not the photographic subject is positioned within a predetermined range in the image. If it determines that the photographic subject is not positioned in the predetermined range (STEP909; No), the process returns to the procedure STEP901.

Meanwhile, if the target selector 2023 determines that the photographic subject is positioned within the predetermined range (STEP909: Yes), it sets the photographic subject that has been determined as being within the predetermined range as a target (STEP910). Then, the firing command issuer 2024 sends a firing command to the control circuit 104 in the surveillance camera unit 10 (STEP908). As a result, the control circuit 104 in the surveillance camera unit 10 gives a firing instruction to the paint bullet firing apparatus 102 and the paint bullet firing apparatus 102 fires a paint bullet.

As described above, in Embodiment 3, when the firing mode is the auto state, if the extracted photographic subject is positioned within a predetermined range, it is possible to automatically set the photographic subject as a target and fire a paint bullet at the target. Accordingly, if settings are made so that a paint bullet will be fired when, for example, a photographic subject is in the vicinity of a doorway, a paint bullet is fired when a suspicious figure attempts to leave, which can ensure security for ordinary people without carelessly provoking the suspicious figure. Moreover, it is possible to fire a paint bullet at the suspicious figure without requiring the operator's monitoring and specification. Furthermore, because the firing mode can be switched also in Embodiment 3, flexible use of the security system 1 is made possible by the operator's selecting a firing mode according to a relevant purpose.

### Embodiment 4

Embodiment 4 is characterized in that two video cameras are used to more accurately train the sight of the paint bullet firing apparatus on a photographic subject. Specifically speaking, in this embodiment, a first video camera provides an image used for the operator to specify a photographic subject on the touch panel screen and a second video camera is used to trains the sight of the paint bullet firing apparatus 102 on the specified photographic subject to fire a paint bullet at the photographic subject.

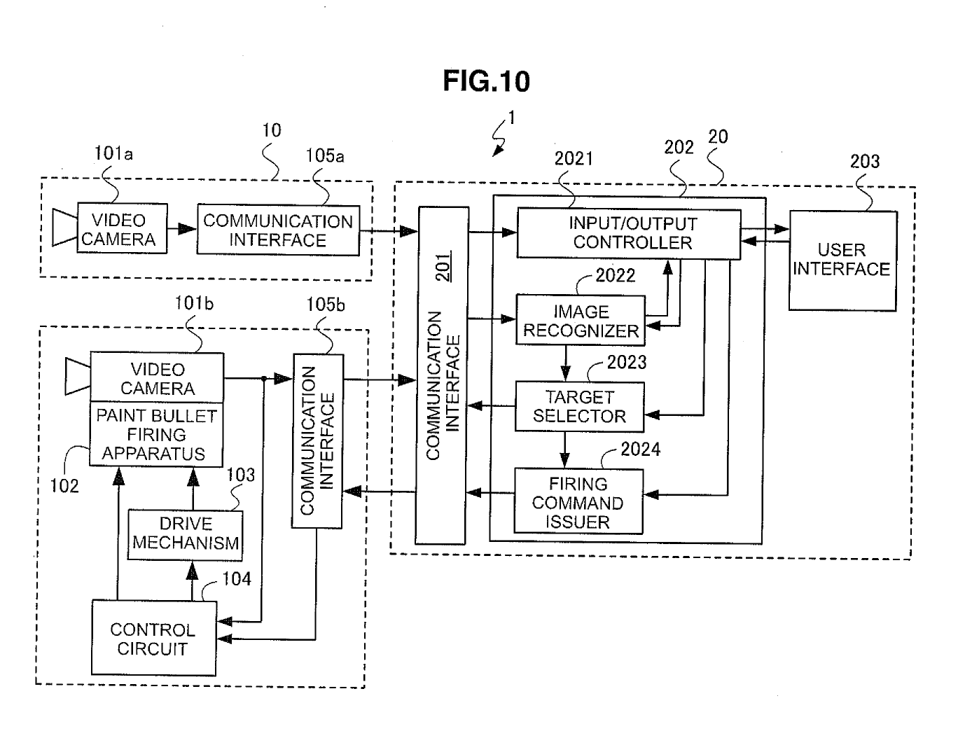

FIG. 10 is a block diagram illustrating a security system 1 according to Embodiment 4 of this invention. As shown in the drawing, a first surveillance camera unit 10a and a second surveillance camera unit 10b are provided in Embodiment 4. In the drawing, the constituent elements that are the same as those in the above embodiments are given the same reference numerals.

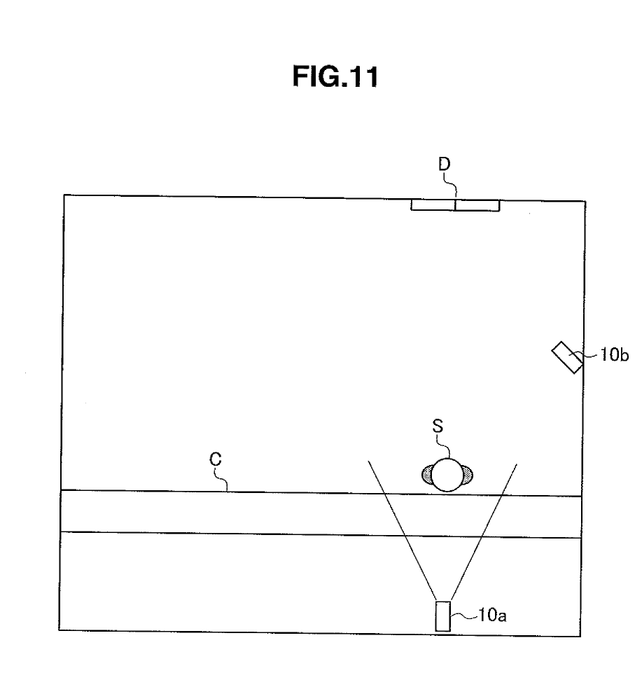

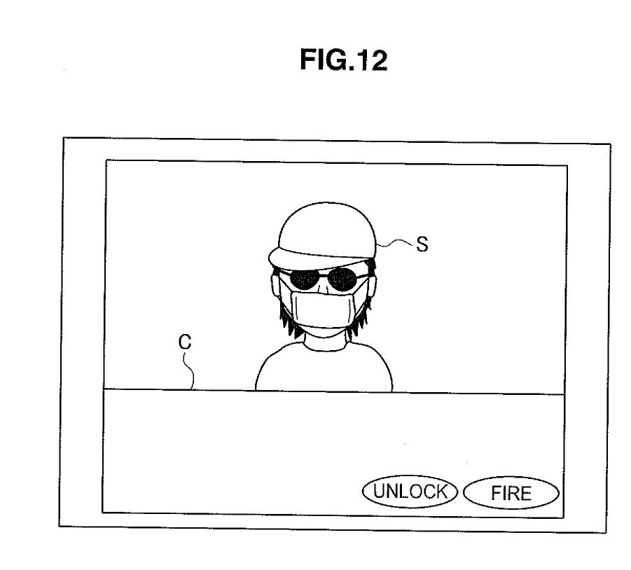

The first surveillance camera unit 10a, which is exclusively used to provide images to an operator, includes a video camera 101a and a communication interface 105a. A video signal obtained by the video camera 101a is sent to the terminal device 20 just as in the above embodiments. As shown in FIG. 11, the first surveillance camera unit 10a is placed, for example, behind a counter in a store and directed outside so that the upper body of a suspicious figure can be captured clearly. FIG. 12 shows an image taken at such a time by the surveillance camera unit 10a and displayed on the touch panel screen.

The second surveillance camera unit 10b is used for training the sight of the paint bullet firing apparatus 102 on the photographic subject that has been captured by the first surveillance camera unit 10a, and includes a video camera 101b, a paint bullet firing apparatus 102, a drive mechanism 103, a control circuit 104, and a communication interface 105b. The second surveillance camera unit 10b has almost the same structure and functions as the surveillance camera unit 10 in the above embodiments.

Also, the terminal device 20 has almost the same structure and functions as the one described in the above embodiments. The following description refers to operation of the security system 1 according to Embodiment 4.

A video signal obtained by the video camera 101a is sent via the communication interface 105a to the terminal device 20. The terminal device 20 displays an image that is based on the video signal on the touch panel screen and extracts a photographic subject by means of the image recognizer 2022. When the operator specifies a photographic subject via the touch panel screen, the target selector 2023 sets the specified photographic subject as a target and sends target information via the communication interface 201 to the second surveillance camera unit 10b. Target information includes positional information and characteristic information for the photographic subject that has been set as a target.

Having received the target information, the control circuit 104 in the second surveillance camera unit 10b identifies the photographic subject that has been set as a target in the image that is based on the video signal obtained by the video camera 101b, and controls the drive mechanism 103 so that the photographic subject is positioned in the center of the image. When the firing command issuer 2024 in the terminal device 20 detects, with the firing mode in the unlocked state, the firing button having been selected via the touch panel screen, it sends a firing command to the second surveillance camera unit 10b.

As described above, according to Embodiment 4, because a photographic subject can be specified using an image from the video camera 101a that is different from the video camera 101b used for training the sight of the paint bullet firing apparatus 102 on the target, it is possible to clearly capture the face of a suspicious figure and ensure that the suspicious figure is set as a target.

### Embodiment 5

Embodiment 5 is characterized in that a distance to a photographic subject that has been set as a target is measured and the elevation angle of the firing port 14 of the paint bullet firing apparatus 102 is adjusted according to the distance.

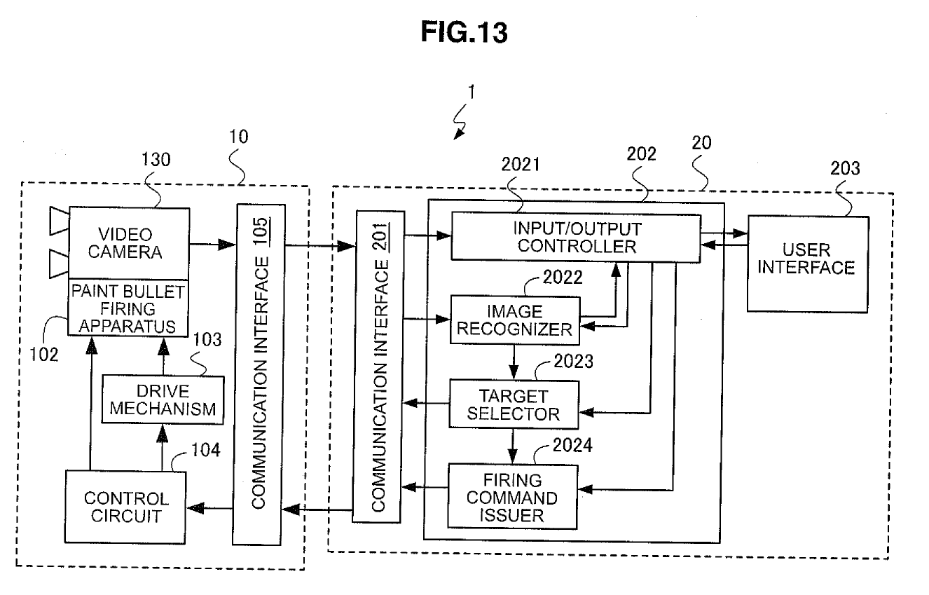

FIG. 13 is a block diagram illustrating the structure of a security system 1 according to Embodiment 5 of this invention. The security system 1 in Embodiment 5 is different from the one in Embodiment 1 in that, in Embodiment 5, a stereo graphic video camera 130 is used for making it possible to calculate the distance to a photographic subject; and the direction of the surveillance camera unit 10 is controlled according to the distance calculated using a stereo image from the video camera 130. The target selector 2023 calculates the distance in this embodiment.

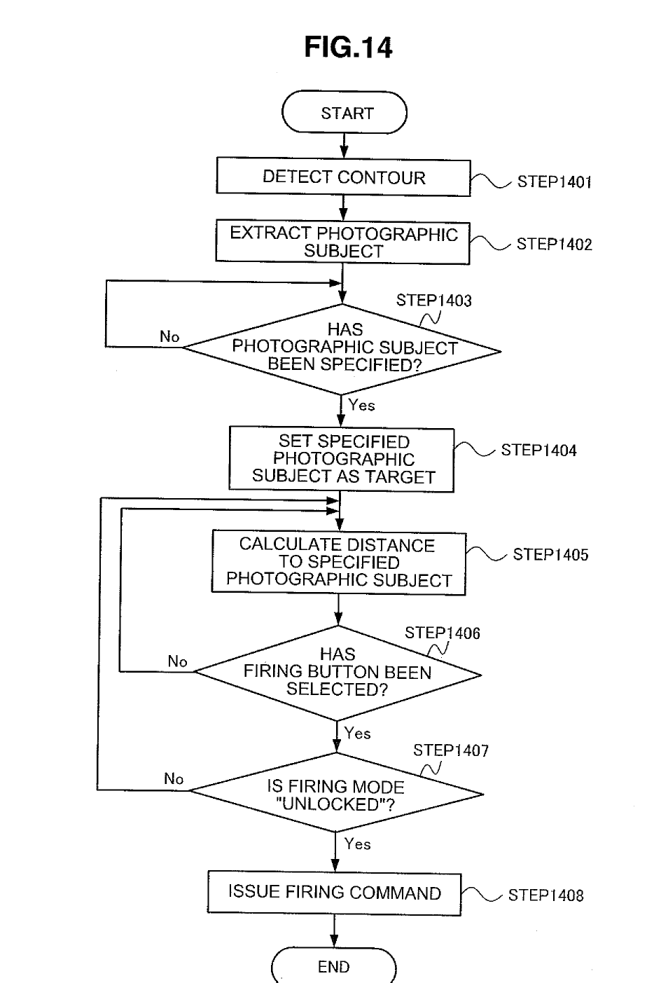

FIG. 14 is a flowchart for explaining processing by the controller 202 in the terminal device 20 according to Embodiment 5 of this invention.

As shown in FIG. 14, when the image recognizer 2022 in the controller 202 receives a video signal from the video camera 130, it detects a contour in the image using a predetermined image recognition technique (STEP1401), and extracts a photographic subject that should be recognized as a figure (STEP1402). The extracted photographic subject may be marked, for example, on the touch panel screen.

When the photographic subject has been extracted, the target selector 2023 determines, based on an input signal from the touch panel screen, whether or not the extracted photographic subject has been specified (STEP1403). If the target selector 2023 determines that the photographic subject has been specified (STEP1403: Yes), it sets the specified photographic subject as a target (STEP1404). The procedures so far are the same as those in Embodiment 1.

Next, the target selector 2023 calculates, using a stereo image from the video camera 130, the distance from the surveillance camera unit 10 to the photographic subject that has been set as a target, and sends a control command, which has been amended to ensure that a paint bullet hits the target, to the surveillance camera unit 10 (STEP1403: Yes). Having received the control command, the control circuit 104 in the surveillance camera unit 10 adjusts the elevation angle of the firing port 14. The subsequent procedures are similar to the procedures STEP305 to STEP307 in FIG. 3, and so have accordingly been omitted.

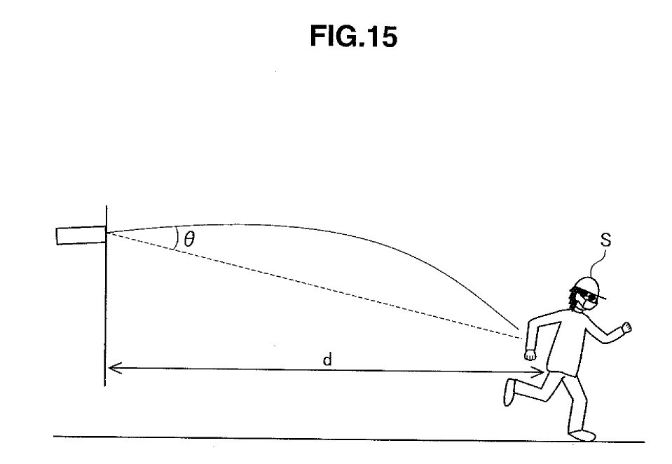

FIG. 15 is a schematic diagram illustrating the firing angle of a paint bullet, which is fired from the paint bullet firing apparatus 102 according to Embodiment 5. A fired paint bullet follows a free-fall parabola. Therefore, if the distance d to a target is small, it is possible to make a paint bullet hit the photographic subject positioned in the center of the image by firing the paint bullet simply in the direction of the line of sight of the surveillance camera unit 10. However, if the distance d to the target is great, a paint bullet fired simply in the direction of the axis of the line of sight of the surveillance camera unit 10 may possibly not reach the target and the photographic subject may move away before the paint bullet reaches it, thus making it impossible to hit the target. In embodiment 5, the elevation angle of the firing port 14 is adjusted according to the distance d to the photographic subject. The elevation angle is adjusted such that, for example, the sight of the paint bullet firing apparatus 102 is trained on a lower position in the image according to the distance. Alternatively, it is possible to employ a configuration where the angle of the firing port 14 of the paint bullet firing apparatus 102 is adjusted relative to the video camera 130.

The distance to a photographic subject is calculated using the stereo graphic video camera 130 in Embodiment 5, however, this invention is not limited to this configuration. For example, the distance may be calculated using an infrared beam or ultrasound.

### Embodiment 6

Embodiment 6 is characterized in that a separate video camera detects a part of a body that is colored in the collision with a paint bullet and tracks that part.

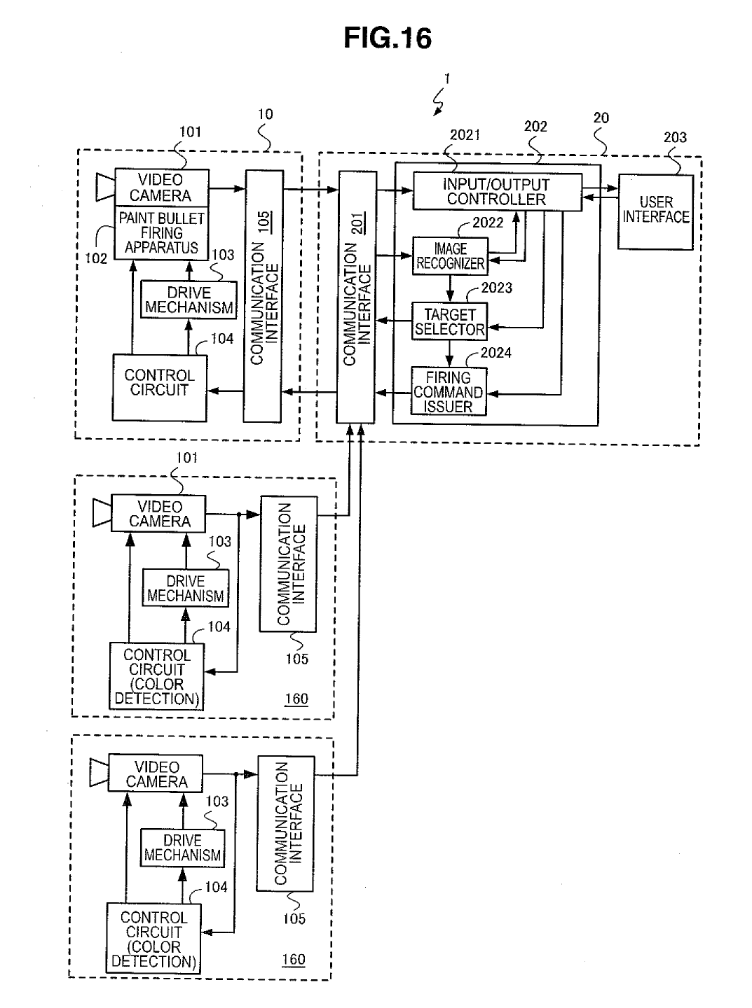

FIG. 16 is a block diagram illustrating the structure of the security system 1 according to Embodiment 6 of this invention.

As shown FIG. 16, the security system 1 in Embodiment 6 is different from the one in Embodiment 1 in that it includes a plurality of tracking surveillance camera units 160. The tracking surveillance camera units 160 in this embodiment are structured to detect specific light wavelengths (colors) and control the directions of axes of the lines of sights to track the sources of the wavelengths.

Suppose that a paint bullet has hit a suspicious figure S by the method described in, for example, Embodiment 1. In this case, when the control circuit 104 in a tracking surveillance camera unit 160 detects a part of the body that emits a specific light wavelength in the image that is based on the video signal, it sets the part as a tracking target and controls the drive mechanism 103 so that the part is positioned in the center of the image. When the control circuit 104 detects the part moving, it controls the drive mechanism 103 so that the part is positioned in the center of the image. Images from the plurality of tracking surveillance camera units 160 switch from one to another and are displayed on the touch panel screen. Alternatively, more than one image may be displayed at the same time on the touch panel screen by splitting the screen.

As described above, according to Embodiment 6, it is possible to track with certainty a suspicious figure who has been hit by a paint bullet and is running away.

### Embodiment 7

Embodiment 7 is characterized in that trapping nets are fired in place of paint bullets.

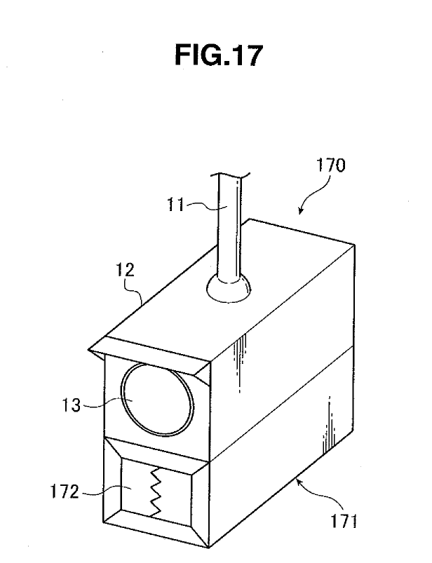

FIG. 17 is an appearance diagram of a surveillance camera unit for use in the security system according to Embodiment 7 of this invention. As shown in the drawing, a trapping net firing apparatus 171 is provided below the surveillance camera unit 170 in place of a paint bullet firing apparatus. The trapping net firing apparatus 171 is an apparatus for firing trapping nets (not shown in the drawing) from a firing port 172 by means of, for example, the resilience of an elastic spring. The processing to fire a trapping net is the same as the one for paint bullets, and accordingly has been omitted.

As described above, according to Embodiment 7, the operator can easily train the sight of the trapping net firing apparatus 171 on a photographic subject by specifying the photographic subject in the image that is obtained by the video camera 101 and displayed on the touch panel screen. Accordingly, by specifying the photographic subject and selecting the firing button on the touch panel screen, the operator can fire a trapping net at the photographic subject. Moreover, if the firing mode is the locked state, the operator cannot fire a trapping net unless the operator selects a mode switching button on the touch panel screen to switch to the unlocked state, thereby making it possible to prevent firing by mistake.

### Other Embodiments

The above embodiments have been described as examples for illustrating this invention and are not intended to limit this invention to the above embodiments. This invention can be implemented in various forms without departing from the scope of the invention. For example, it is within the scope of this invention to combine the above embodiments as appropriate. Moreover, while the various kinds of procedures have been described sequentially in the above embodiments, this invention is not limited to the described sequence. Accordingly, the sequence for the procedures may be changed or more than one procedure may be performed in parallel, so long as there is no inconsistency in the result of the procedures.

Although the controller 202 in the terminal device 20 performs the processing to track a photographic subject that has been set as a target in the above embodiments, this invention is not limited to that configuration. For example, it is possible to include a tracking function in the control circuit 104 in the surveillance camera unit 10 so that it executes the tracking control without requiring communication with the terminal device 20.

### INDUSTRIAL APPLICABILITY

This invention can be can be utilized in a wide variety of security systems using, for example, video cameras for crime prevention/security.

While the invention has been described with respect to a limited number of embodiments, those skilled in the art, having benefit of this disclosure, will appreciate that other embodiments can be devised which do not depart from the scope of the invention as disclosed herein.

What is claimed is:

1. A security system comprising:
a surveillance camera unit including: a video camera; and a paint bullet firing apparatus for firing a paint bullet from a firing port that is arranged aligned in a direction of an axis of line of sight of the video camera;
a user interface for displaying an image that is sent from the video camera and accepting a predetermined input with respect to the displayed image from an operator; and
a controller for controlling the surveillance camera unit,
wherein,
the controller includes: an image recognizer for extracting a predetermined photographic subject from an image that is sent from the video camera; a target selector for setting, according to a first input it receives from the user interface, the predetermined photographic subject as a target and controlling the direction of the surveillance camera unit so that the predetermined photographic subject is positioned in the vicinity of the center of the image; and a firing command issuer for issuing a paint bullet firing command to the paint bullet firing apparatus according to a second input it receives from the user interface.

2. The security system according to claim 1 wherein, the user interface includes a firing mode button for specifying a firing mode of the paint bullet firing apparatus, and the firing command issuer selectively switches the firing mode of the paint bullet according to the operator's selection of the firing mode button.

3. The security system according to claim 1 wherein, the user interface includes a firing mode button for specifying a firing mode of the paint bullet, the image recognizer extracts a moving body in an image that is sent from the video camera; the target selector sets the moving body as a target; and, when the firing mode is a specific state, after the moving body has been set as a target, the firing command issuer issues a paint bullet firing command to the paint bullet firing apparatus without accepting the second input.

4. The security system according to claim 1 wherein, the target selector measures the distance from the surveillance camera unit to the photographic subject that has been set as the target based on the image from the video camera, and controls the direction of the surveillance camera unit based on the measured distance.

5. The security system according to claim 1 wherein the target selector controls the direction of the surveillance camera unit to track the predetermined photographic subject.

6. The security system according to claim 5, wherein the firing command issuer issues a paint bullet firing command to the paint bullet firing apparatus when the axis of the line of sight of the video camera is directed in a predetermined direction.
